(19) United States
(12) Patent Application Publication
(10) Pub. No.: US 2026/0194959 A1
(43) Pub. Date: Jul. 9, 2026

(54) PROCESSOR AND SYSTEM

(71) Applicant: Fujitsu Limited, Kawasaki-shi (JP)

(72) Inventor: Souta KUSACHI, Yokohama (JP)

(73) Assignee: Fujitsu Limited, Kawasaki-shi (JP)

(21) Appl. No.: 19/413,312

(22) Filed: Dec. 9, 2025

(30) Foreign Application Priority Data
Jan. 9, 2025 (JP) 2025-003272

(51) Int. Cl. G06F 1/3234; G06F 1/3225

(52) U.S. Cl. CPC G06F 1/3275; G06F 1/3225

(57) ABSTRACT

A processor includes a memory access controller that accesses a memory based on a memory access request, a storage that stores a plurality of limit values of an access bandwidth of the memory in association with a plurality of power consumption values of the memory, respectively, a power capping controller that acquires a limit value corresponding to a specified power consumption value from the storage and controls the memory access controller so that the access bandwidth is the acquired limit value or less, and an initial setting circuit that repeatedly accesses the memory during an initialization mode, monitors a power consumption value for a case where the access bandwidth is not limited and a plurality of the power consumption values when the limit value is gradually varied, and stores the plurality of limit values in the storage in association with the plurality of monitored power consumption values, respectively.

### CROSS-REFERENCE TO RELATED APPLICATIONS

This application is based upon and claims the benefit of priority of the prior Japanese Patent Application No. 2025-003272, filed on Jan. 9, 2025, the entire contents of which are incorporated herein by reference.

### FIELD

The embodiments discussed herein are related to processors and systems.

### BACKGROUND

There is a known power capping technique capable of achieving an appropriate performance while suppressing a maximum power consumption value by setting an upper limit value to the power consumption. In a memory system, there is a proposed technique that limits the number of accesses to a memory, such as a dual inline memory module (DIMM) or the like, at predetermined time intervals so that the maximum power consumption value of the memory does not exceed a power consumption value selected in advance (refer to Japanese National Publication of International Patent Application No. 2005-507111, for example).

However, in a case where a relationship between the power consumption value and the number of accesses selected in advance differs from a relationship between the actual power consumption value and the number of accesses, an error occurs between the power consumption value expected by limiting the number of accesses and the actual power consumption value. For example, in a case where the number of accesses per unit time is set to a small value because the expected power consumption value is larger than the actual power consumption value, the processing performance may deteriorate. On the other hand, in a case where the number of accesses per unit time is set to a large value because the expected power consumption value is smaller than the actual power consumption value, the power consumption value may exceed the upper limit value.

### SUMMARY

Accordingly, it is an object in one aspect of the embodiments to suppress a deterioration of a power capping accuracy by setting a limit value of an access bandwidth according to an actual power consumption value of a memory.

According to one aspect of the embodiments, a processor includes a memory access controller configured to access a memory based on a memory access request; a storage configured to store a plurality of limit values of an access bandwidth of the memory in association with a plurality of power consumption values of the memory, respectively; a power capping controller configured to acquire a limit value corresponding to a specified power consumption value from the storage and control the memory access controller so that the access bandwidth is less than or equal to the acquired limit value; and an initial setting circuit configured to repeatedly access the memory during an initialization mode, monitor a power consumption value for a case where the access bandwidth is not limited and a plurality of the power consumption values when the limit value is gradually varied, and store the plurality of limit values in the storage in association with the plurality of monitored power consumption values, respectively.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a system installed with a processor related to and other than a processor according to an embodiment;

FIG. 2 is a diagram illustrating an example of a bandwidth limitation table illustrated in FIG. 1;

FIG. 3 is a diagram for explaining an example of limiting a memory access frequency according to an access limitation ratio;

FIG. 4 is a diagram for explaining an example of performing a bandwidth limitation of a memory module according to an upper limit request of power consumption;

FIG. 5 is a block diagram illustrating an example of a configuration of a system installed with the processor according to the embodiment;

FIG. 6 is a diagram illustrating an example of updating the bandwidth limitation table illustrated in FIG. 5; and

FIG. 7 is a flow chart illustrating an example of an operation of updating the bandwidth limitation table illustrated in FIG. 5.

### DESCRIPTION OF EMBODIMENTS

Hereinafter, embodiments will be described with reference to the accompanying drawings. In the following description, a signal line through which a signal or information is transmitted is designated by the same reference numeral as the signal name. First, an example of a system installed with a processor related to and other than a processor according to an embodiment will be described.

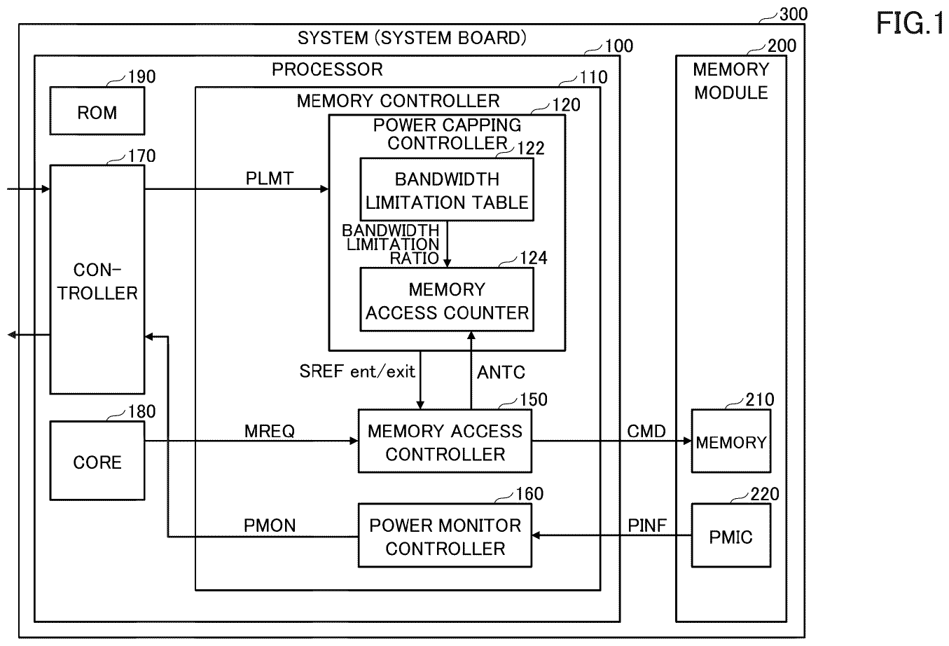

FIG. 1 illustrates an example of a configuration of a system 300 installed with a processor 100 related to and other than a processor 100A according to an embodiment. The processor 100 illustrated in FIG. 1 is not known. For example, the system 300 illustrated in FIG. 1 may take a form of a system board mounted with the processor 100, such as a central processing unit (CPU) or the like, and a memory module 200. The processor 100 includes a memory controller 110, a controller 170, a core 180, and a read only memory (ROM) 190. The memory controller 110 includes a power capping controller 120 including a bandwidth limitation table 122 and a memory access counter 124, a memory access controller 150, and a power monitor controller 160.

The memory module 200 includes a memory 210, such as a synchronous dynamic random access memory (SDRAM) or the like, and a power management integrated circuit (PMIC) 220. The memory 210 is an example of a volatile memory that needs to be periodically refreshed to hold data. The PMIC 220 has a function of generating various power source voltages used in the memory module 200, and a function of outputting power information PINF indicating a power consumption of the memory module 200 in response to a request.

Firmware or the like to be executed by the core 180 is prestored in the ROM 190. The controller 170 controls the entire system 300. The controller 170 outputs an upper limit request PLMT indicating an upper limit value of the power consumption of the memory module 200 specified by a user who uses the system 300 to the power capping controller 120 of the memory controller 110, for example. The controller 170 outputs a power monitor value PMON received from the power monitor controller 160 in response to a request from the user. The controller 170 may be implemented by firmware executed by the core 180, or may be implemented by a circuit.

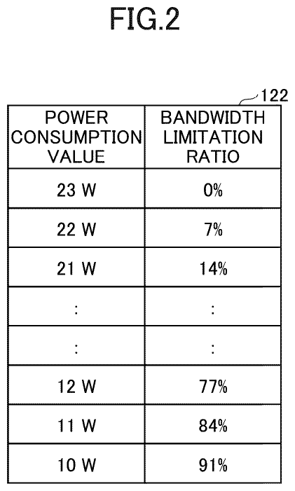

The bandwidth limitation table 122 of the power capping controller 120 prestores a bandwidth limitation ratio for every power consumption value of the memory module 200. An example of the bandwidth limitation table 122 is illustrated in FIG. 2. The bandwidth limitation table 122 is an example of a storage that stores a plurality of bandwidth limitation ratios of the access bandwidth of the memory module 200 in association with a plurality of power consumption values of the memory module 200. The bandwidth limitation table 122 may be disposed outside the power capping controller 120 or inside the memory controller 110.

The power capping controller 120 acquires the bandwidth limitation ratio stored in the bandwidth limitation table 122 in association with the power consumption value specified by the upper limit request PLMT of the power consumption. The power capping controller 120 obtains a limit value, which is an upper limit of a number of accesses to the memory module 200 per unit time, from the acquired bandwidth limitation ratio.

As illustrated in the following formula (1), the bandwidth limitation ratio indicates a ratio of a number of inhibited memory accesses per unit time (limit value) with respect to an upper limit of the number of memory accesses per unit time, and corresponds to an access bandwidth cap. The number of memory accesses to be inhibited per unit time is a value obtained by subtracting a number of accessible memory accesses from an upper limit of the number of memory accesses per unit time.

$$( bandwidth limitation ratio ) [ \% ] = ( number of inhibited memory accesses per unit time ) / ( upper limit of number of memory accesses per unit time ) \qquad ( 1 )$$

The bandwidth limitation ratio is related to the number of accesses to the memory module 200 per unit time, and is 0% in a case where there is no upper limit of the number of accesses, and increases as the upper limit of the number of accesses decreases, for example. In the bandwidth limitation table 122, a limit value (upper limit value) of the number of accesses may be stored in place of the bandwidth limitation ratio for every power consumption value of the memory module 200. In this case, the limit value of the number of accesses becomes smaller as the bandwidth limitation ratio of the number of accesses becomes higher.

The memory access counter 124 receives an access notification ANTC from the memory access controller 150 every time a memory access request MREQ is issued, and counts a number of times the access notification ANTC is received. The power capping controller 120 compares a count value of the memory access counter 124 for every unit time with the upper limit value of the number of accesses obtained from the bandwidth limitation ratio. For example, the power capping controller 120 resets the count value of the memory access counter 124 for every unit time.

In a case where the count value of the memory access counter 124 exceeds the upper limit value of the number of accesses for every unit time, the power capping controller 120 performs a power capping control to reduce an issuance frequency of an access command CMD to the memory module 200. Accordingly, the power capping controller 120 can obtain a number of the memory access requests MREQ issued per unit time using a simple circuit. Further, the power capping controller 120 can perform the power capping control by comparing the obtained number of memory access requests MREQ issued per unit time with the upper limit value of the number of accesses obtained from the bandwidth limitation ratio.

For example, when the count value exceeds the upper limit value of the number of accesses within a unit time, the power capping controller 120 outputs an entry request “ent” for causing a transition of the memory 210 to a self-refresh mode SREF to the memory access controller 150. In a case where the power capping controller 120 outputs the entry request “ent” to the memory access controller 150, the power capping controller 120 outputs an exit request “exit” for releasing the memory 210 from the self-refresh mode SREF to the memory access controller 150 at an end of the unit time.

Accordingly, within the unit time, the power capping controller 120 can set the memory 210 to the self-refresh mode SREF during a time period from a time when the count value exceeds the upper limit value of the number of accesses to a time when the unit time ends. The memory 210 intermittently performs a minimum number of refresh operations to maintain data held in the memory 210 during the self-refresh mode SREF. For this reason, the power consumption value of the memory 210 during the self-refresh mode SREF is significantly smaller than the power consumption value when the memory 210 operates in response to the access command CMD. In a case where a no operation command (NOP command) is output to the memory 210 which is a volatile memory during a time period from a time when the count value exceeds the upper limit value of the number of accesses to a time when the unit time ends, no refresh operation is performed, and thus, there is a possibility of losing the data held in the memory 210.

The memory access controller 150 outputs the access command CMD (a write command, a read command, or the like) to the memory module 200 in response to the memory access request MREQ issued by the core 180. However, in a case where the memory access controller 150 receives the entry request “ent” from the power capping controller 120, the memory access controller 150 causes the memory 210 to enter the self-refresh mode.

The memory access controller 150 inhibits the issuance of the access command CMD in response to the memory access request MREQ to the memory module 200 while the memory 210 is in the self-refresh mode. Further, the memory access controller 150 holds the access command CMD, the issuance of which is inhibited, in a command queue (not illustrated). When the memory access controller 150 receives the exit request “exit”, the memory access controller 150 releases the self-refresh mode of the memory 210. The memory access controller 150 successively outputs the access commands CMD held in the command queue to the memory module 200, based on the cancellation of the self-refresh mode.

Accordingly, the number of access commands CMD issued to the memory module 200 per unit time can be reduced as the bandwidth limitation ratio becomes higher. Hence, the power consumption of the memory module 200 can be reduced according to the bandwidth limitation ratio corresponding to the upper limit request PLMT of the power consumption. That is, it is possible to prevent the power consumption of the memory module 200 from exceeding the upper limit value of the power consumption specified by the user.

The power monitor controller 160 outputs the power consumption value of the memory module 200 indicated by the power information PINF read from the PMIC 220 to the controller 170 as the power monitor value PMON.

FIG. 2 illustrates an example of the bandwidth limitation table 122 illustrated in FIG. 1. The bandwidth limitation table 122 has a plurality of fields in which the bandwidth limitation ratios (%) are stored in association with a plurality of power consumption values of the memory module 200. A power consumption value 23 W illustrated in a first row of the bandwidth limitation table 122 is an upper limit of an actual power consumption value of the memory module 200, and indicates a value when the memory module 200 is caused to continuously perform the write access operation, for example. In FIG. 2, the power consumption value is indicated in 1 W increments, but the increment (or step size) of the power consumption value is not limited to 1 W, and may be 0.5 W, 2 W, or the like. Moreover, a lower limit of the power consumption value set in the bandwidth limitation table 122 may be smaller than 10 W or may be larger than 10 W. The bandwidth limitation ratios illustrated in the bandwidth limitation table 122 of FIG. 2 are examples of states before an updating operation of the bandwidth limitation table 122 is performed (an initial state or a state after a previous startup of the system 300).

The power capping controller 120 acquires, from the bandwidth limitation table 122, a bandwidth limitation ratio corresponding to the upper limit request PLMT (any one of 23 W to 10 W in increments of 1 W) of power consumption received from the user via the controller 170. In addition, the power capping controller 120 controls the memory access controller 150 according to the acquired bandwidth limitation ratio, and performs a power capping control so that a limitation ratio of the access bandwidth of the memory module 200 becomes higher than or equal to the bandwidth limitation ratio.

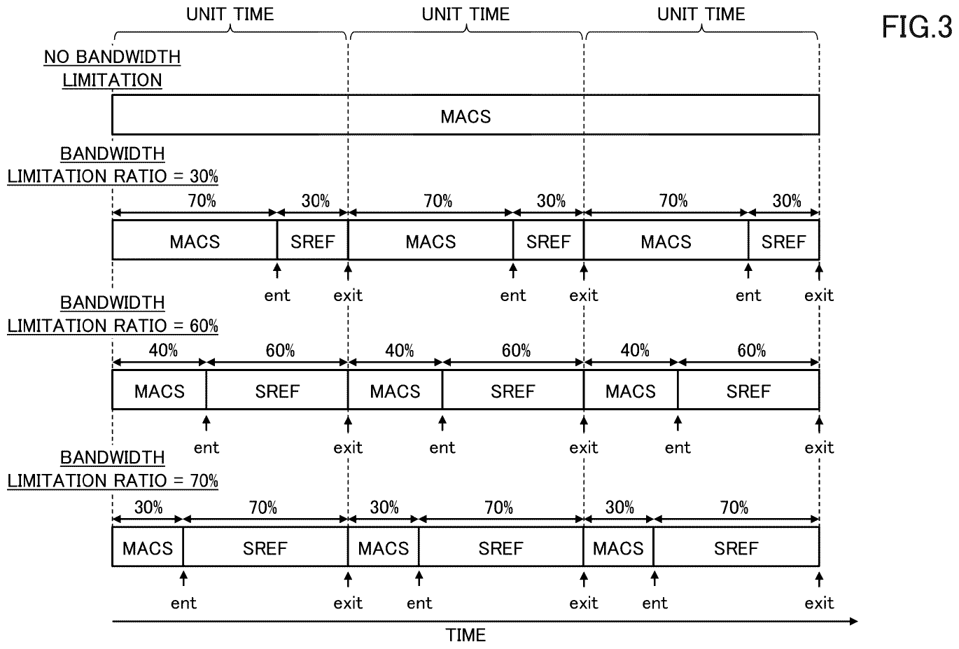

FIG. 3 illustrates an example of limiting a memory access frequency according to an access limitation ratio. In FIG. 3, to facilitate understanding of the description, it is assumed for the sake of convenience that the core 180 always issues the memory access request MREQ at a maximum issuance frequency.

In the case where the bandwidth limitation ratio is 0% (no bandwidth limitation), the self-refresh SREF is not inserted, and the memory module 200 performs the memory access MACS in response to the memory access request MREQ. In a case where the bandwidth limitation ratio is higher than 0%, a number of memory accesses MACS obtained by subtracting the number of inhibited memory accesses per unit time from the upper limit of the number of memory accesses per unit time indicated by the formula (1) described above is performed from a beginning of the unit time for every unit time. In the case where the memory access MACS is performed a number of times determined by the bandwidth limitation ratio, a remaining time of the unit time enters the self-refresh mode. Hereinafter, the self-refresh mode is also referred to as the self-refresh mode SREF.

In a case where the bandwidth limitation ratio is 30%, the memory access MACS is performed in the first 70% of the unit time, and the remaining 30% of the unit time becomes the self-refresh mode SREF. In a case where the bandwidth limitation ratio is 60%, the memory access MACS is performed in the first 40% of the unit time, and the remaining 60% of the unit time becomes the self-refresh mode SREF. In a case where the bandwidth limitation ratio is 70%, the memory access MACS is performed in the first 30% of the unit time, and the remaining 70% of the unit time becomes the self-refresh mode SREF.

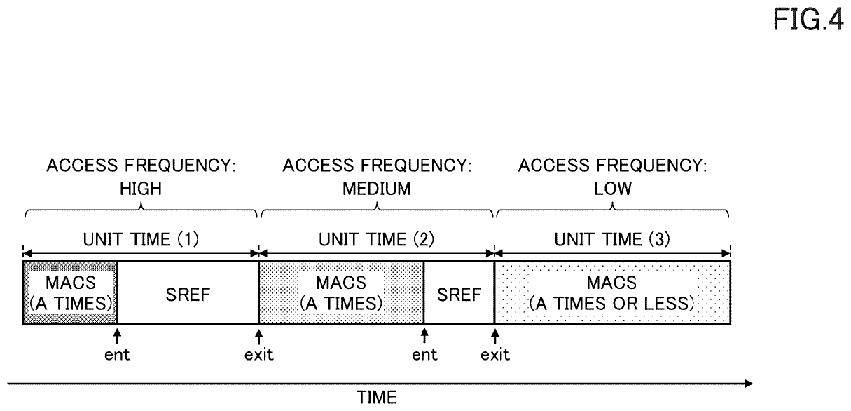

FIG. 4 illustrates an example of performing the bandwidth limitation of the memory module 200 according to the upper limit request PLMT of the power consumption. For example, in a case where the upper limit value of the power consumption of the memory module 200 instructed by the user is less than or equal to 22 W in FIG. 2, the bandwidth limitation of the memory access MACS of the memory module 200 occurs due to the power capping control.

In the example illustrated in FIG. 4, it is assumed for the sake of convenience that the upper limit of the number of memory accesses MACS with respect to the memory module 200 within the unit time is A times. For example, the memory access counter 124 in FIG. 1 is reset to “0” every time the unit time ends.

During a first unit time (1), the issuance frequency of the memory access request MREQ issued by the core 180 is high, and the access frequency of the memory access MACS with respect to the memory module 200 is high. In this case, the number of memory accesses MACS reaches the upper limit of A times in a first half of the unit time (1), and a duration of the self-refresh mode in which the self-refresh SREF is performed becomes relatively long because the upper limit of A times is reached quickly in a short time.

During a next unit time (2), the issuance frequency of the memory access request MREQ issued by the core 180 is medium, and the access frequency of the memory access MACS with respect to the memory module 200 is medium. In this case, the number of memory accesses MACS reaches the upper limit of A times in the latter half of the unit time (2), and the duration of the self-refresh mode SREF becomes relatively short because the upper limit of A times is reached slowly in a relatively long time.

During a next unit time (3), the issuance frequency of the memory access request MREQ issued by the core 180 is low, and the access frequency of the memory module 200 is low. In this case, the access count reaches the upper limit of A at an end of the unit time (3) or does not reach the upper limit of A within the unit time (3), and thus, the memory 210 does not enter the self-refresh mode SREF.

As described above, it is possible to adjust the duration of the self-refresh mode SREF, according to the bandwidth limitation ratio corresponding to the power consumption value instructed by the user with the upper limit request PLMT of the power consumption and the issuance frequency of the memory access request MREQ. By determining the duration of the self-refresh mode SREF based on the actual number of accesses per unit time, the power consumption value of the memory module 200 can be reduced to less than or equal to the upper limit value instructed by the user regardless of the access frequency of the memory module 200.

In the case where the access to the memory module 200 is limited by using the preset bandwidth limitation table 122, the actual power consumption value of the memory module 200 may deviate from the upper limit value of the power consumption requested by the user. This is because the actual power consumption of the memory module 200 varies depending on a vendor of the memory module 200, a length of an interconnect connected to the memory module 200 on the system board, an environmental temperature during operation of the system 300, or the like.

In a case where the actual power consumption value of the memory module 200 is lower than the upper limit value of the power consumption requested by the user, a processing performance of the processor 100 may become lower than an expected processing performance. On the other hand, in a case where the actual power consumption value of the memory module 200 is higher than the upper limit value of the power consumption requested by the user, a power supply current value of the system board may increase to a value higher than a rated value.

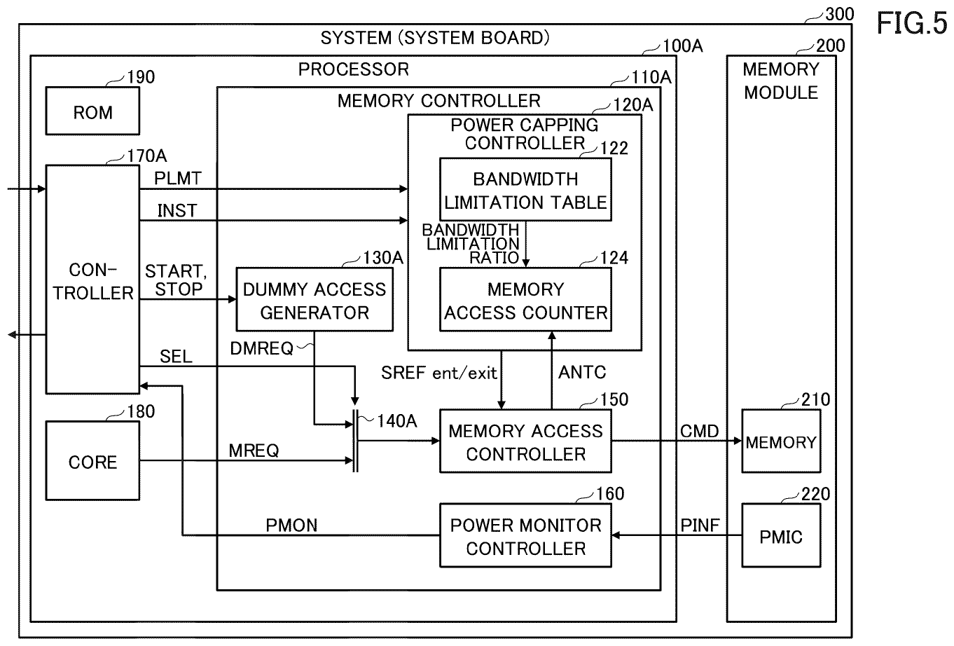

FIG. 5 illustrates an example of a configuration of a system installed with a processor 100A according to an embodiment. In FIG. 5, constituent elements that are the same as those illustrated in FIG. 1 are designated by the same reference numerals, and a detailed description thereof will be omitted. The processor 100A illustrated in FIG. 5 has a configuration similar to that of the processor 100 illustrated in FIG. 1, except that a function of a controller 170A is different from the function of the controller 170 illustrated in FIG. 1 and a configuration of the memory controller 110A is different from the configuration of the memory controller 110 illustrated in FIG. 1. The bandwidth limitation table 122 may be disposed outside the power capping controller 120 or inside the memory controller 110A.

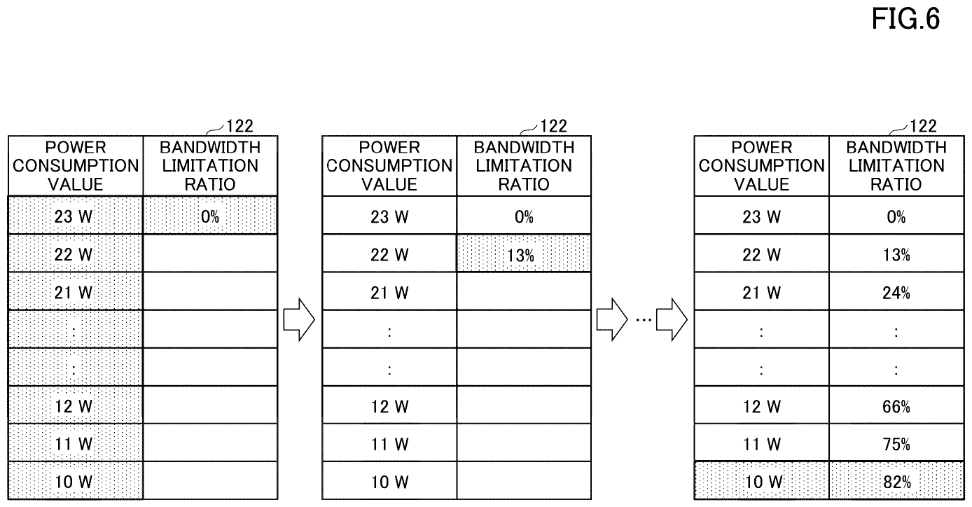

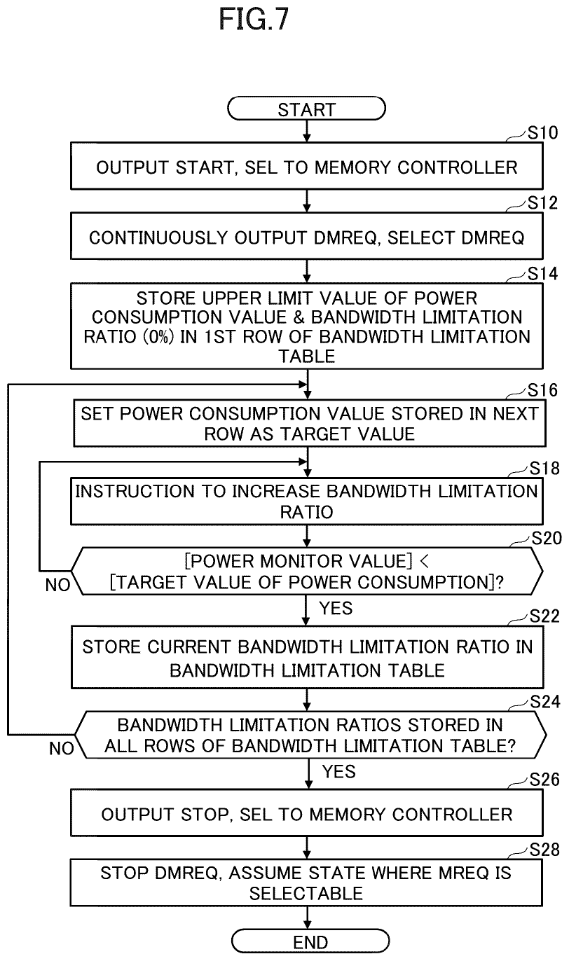

In addition to the functions of the controller 170 illustrated in FIG. 1, the controller 170A has a function of outputting various instructions to the memory controller 110A in an initialization sequence at a time of a startup or a restart (or reboot) of the system 300. Accordingly, the memory controller 110A can update the bandwidth limitation table 122 according to the actual power consumption of the memory module 200 as will be described with reference to FIG. 6 and FIG. 7. The controller 170A is an example of an initial setting circuit. A mode during which the initialization sequence is performed is an example of an initialization mode to which the system 300 makes a transition at the time of the startup.

The memory controller 110A includes a power capping controller 120A in place of the power capping controller 120 illustrated in FIG. 1, and includes a dummy access generator 130A and a selector 140A in addition to the configuration of the memory controller 110 illustrated in FIG. 1. The dummy access generator 130A and the selector 140A are installed in the memory controller 110A as circuits. In addition to the functions of the power capping controller 120 illustrated in FIG. 1, the power capping controller 120A has a function of individually updating each row of the bandwidth limitation table 122 based on an instruction INST received from the controller 170A.

The controller 170A outputs a start instruction START to start a calibration process of the bandwidth limitation ratio of the bandwidth limitation table 122 and a stop instruction STOP to stop the calibration process to the dummy access generator 130A. The controller 170A outputs the instruction INST to gradually vary the bandwidth limitation ratio of the bandwidth limitation table 122 to the power capping controller 120A. The controller 170A outputs a selection instruction SEL for causing the selector 140A to select a dummy memory access request DMREQ from a time when the start instruction START is output until a time when the end instruction STOP is output.

For example, the controller 170A generates the start instruction START, the end instruction STOP, the instruction INST, and the selection instruction SEL for selecting the dummy memory access request DMREQ at the time of the startup (including restart) of the system 300. An example of the process of updating the bandwidth limitation table 122 is illustrated in FIG. 6 and FIG. 7.

When the dummy access generator 130A receives the calibration start instruction START from the controller 170A, the dummy access generator 130A continuously outputs the dummy memory access request DMREQ at a frequency for the case where the bandwidth is not limited. For this reason, the dummy access generator 130A can continuously output the dummy memory access request DMREQ in a cycle in which the access bandwidth of the memory module 200 becomes a maximum without depending on the operation of the core 180. In contrast, in a case where the dummy memory access request DMREQ is generated by the core 180, it may not be possible to continuously output the dummy memory access request DMREQ in the cycle in which the access bandwidth becomes the maximum, depending on the operation state of the core 180.

In a case where the dummy access generator 130A receives the calibration end instruction STOP from the controller 170A, the dummy access generator 130A stops outputting the dummy memory access request DMREQ. For example, the dummy memory access request DMREQ is a write access request having a large power consumption value of the memory module 200 compared to that of a read access request. Thus, when the bandwidth limitation table 122 is updated as illustrated in FIG. 6 and FIG. 7, the upper limit value of the actual power consumption value of the memory module 200 can be stored in the first row of the bandwidth limitation table 122. The dummy memory access request DMREQ is an example of a memory access request, and the dummy access generator 130A is an example of an access generator that repeatedly generates the memory access request.

The selector 140A selects the dummy memory access request DMREQ and outputs the dummy memory access request DMREQ to the memory access controller 150 while receiving the selection instruction SEL for causing selection of the dummy memory access request DMREQ from the controller 170A. Accordingly, while the controller 170A outputs the selection instruction SEL for causing the selection of the dummy memory access request DMREQ, the supply of the memory access request MREQ issued by the core 180 to the memory access controller 150 is inhibited. During the initialization sequence at the time of the startup or restart of the system 300, the core 180 inhibits the issuance of the memory access request MREQ, and thus, a conflict between the dummy memory access request DMREQ and the memory access request MREQ can be prevented.

FIG. 6 illustrates an example of updating the bandwidth limitation table 122 illustrated in FIG. 5. The updating of the bandwidth limitation table 122 is started at the time of the startup or restart of the system 300. Although the values illustrated in FIG. 2 are held in the fields of the bandwidth limitation ratios before the bandwidth limitation table 122 is updated, the illustration of the values before the updating are omitted and are indicated as blanks in FIG. 6 for the sake of convenience to facilitate the understanding of the description.

First, the controller 170A outputs the start instruction START and the selection instruction SEL for causing the selection the dummy memory access request DMREQ, and causes the memory access controller 150 to repeatedly output the dummy memory access request DMREQ to the memory module 200. The controller 170A reads the power monitor value PMON from the PMIC 220 via the power monitor controller 160. The power consumption value when the memory module 200 is accessed by the successive dummy memory access requests DMREQ becomes the upper limit value (maximum value) of the power consumption value of the memory module 200.

The controller 170A stores the upper limit of the power consumption value indicated by the power monitor value PMON in the first row of the bandwidth limitation table 122, and outputs the instruction INST for setting the bandwidth limitation ratio in the first row to 0% to the power capping controller 120A. In addition, the controller 170A outputs, to the power capping controller 120A, the instruction INST for storing values obtained by successively reducing the upper limit value stored in the first row by 1 W, for example, with respect to the second row to the last row of the bandwidth limitation table 122. The power capping controller 120A sets the bandwidth limitation table 122 to a state illustrated in a left part of FIG. 6 based on the instruction INST. The power consumption value to be successively reduced from the upper limit value is not limited to the 1 W.

Thereafter, the controller 170A outputs an instruction to gradually increase the bandwidth limitation ratio to the power capping controller 120A. The power capping controller 120A gradually increases the time in which the self-refresh SREF is inserted per unit time, thereby gradually increasing the bandwidth limitation ratio. When the power monitor value PMON becomes lower than 22 W stored in the second row of the bandwidth limitation table 122, the controller 170A outputs the instruction INST for storing a current bandwidth limitation ratio (for example, 13%) in the second row of the bandwidth limitation table 122 to the power capping controller 120A. The power capping controller 120A sets the bandwidth limitation table 122 to the state illustrated in a central part of FIG. 6 based on the instruction INST.

When the power monitor value PMON becomes the power value stored in the n-th row of the bandwidth limitation table 122, the controller 170A outputs the instruction INST for storing the current bandwidth limitation ratio in the n-th row of the bandwidth limitation table 122 to the power capping controller 120A. In this case, the n-th row is any one of the third row to the last row. The controller 170A outputs the instruction INST with respect to the n-th row by incrementing n by “1” every time the bandwidth limitation ratio is stored in the bandwidth limitation table 122. The power capping controller 120A successively stores the bandwidth limitation ratios in the bandwidth limitation table 122 based on the instruction INST, and the bandwidth limitation table 122 is finally set to the state illustrated in a right part of FIG. 6.

In a case where the bandwidth limitation ratios are stored in all the rows of the bandwidth limitation table 122, the controller 170A stops the process of updating the bandwidth limitation table 122. In addition, the controller 170A outputs the end instruction STOP and the selection instruction SEL for causing the selector 140A to select the memory access request MREQ. The dummy access generator 130A stops outputting the dummy memory access request DMREQ, and the selector 140A assumes a state of selecting the memory access request MREQ from the core 180. In a case where the power monitor value PMON does not decrease before the bandwidth limitation ratios are stored in the last row of the bandwidth limitation table 122, the controller 170A determines that the bandwidth limitation ratio set by the power capping controller 120A reached 100%. Further, the controller 170A stops the process of updating the bandwidth limitation table 122.

FIG. 7 illustrates an example of an operation of updating the bandwidth limitation table 122 illustrated in FIG. 5. For example, an operation flow of updating the bandwidth limitation table 122 illustrated in FIG. 7 is performed during the initialization sequence at the time of the startup or restart of the system 300. This makes it possible to suppress a deterioration (or decrease) of the accuracy of power capping from the start of the operation of the system 300, according to the power consumption value unique to each memory module 200, a load of the interconnect on the system board, or the like. Because the individual difference in power consumption at the time of the power capping caused by the difference in the type or configuration of the memory module 200 can be minimized, the power capping can be accurately controlled according to the upper limit value of the power consumption of the memory module 200 specified by the user.

First, in step S10, the controller 170A outputs the start instruction START and the selection instruction SEL for causing the selector 140A to select the dummy memory access request DMREQ to the memory controller 110A.

Next, in step S12, the dummy access generator 130A continuously outputs the dummy memory access request DMREQ based on the start instruction START. The selector 140A selects the dummy memory access request DMREQ based on the selection instruction SEL from the controller 170A.

Next, in step S14, the controller 170A reads the power monitor value PMON as the upper limit value of the power consumption, and outputs the instruction INST including the read upper limit value to the memory controller 110A. The power capping controller 120A stores the upper limit value (for example, 22 W) of the power consumption value included in the instruction INST from the controller 170A in the first row of the bandwidth limitation table 122 together with the bandwidth limitation ratio (0%).

In addition, the controller 170A outputs the instruction INST to the power capping controller 120A to lower the power consumption value in a stepwise manner and store the power consumption value in the bandwidth limitation table 122. The power capping controller 120A stores the value successively decreased from the upper limit value stored in the first row, with respect to the second row to the last row of the bandwidth limitation table 122, based on the instruction INST from the controller 170A.

Next, in step S16, the controller 170A sets the power consumption value stored in the next row of the bandwidth limitation table 122 as a target value for obtaining the next bandwidth limitation ratio. Next, in step S18, the controller 170A outputs the instruction INST to increase the bandwidth limitation ratio to the power capping controller 120A. The power capping controller 120A increases the bandwidth limitation ratio based on the instruction INST from the controller 170A.

Next, in step S20, the controller 170A determines whether or not the power monitor value PMON is smaller than the target value of the power consumption value set in step S16. In a case where the power monitor value PMON is smaller than the target value of the power consumption value, the controller 170A advances the process to a process of step S22, and in a case where the power monitor value PMON is greater than or equal to the target value of the power consumption value, the controller 170A returns to the process of step S18.

In step S22, the controller 170A outputs, to the power capping controller 120A, the instruction INST to store the current bandwidth limitation ratio in an updating target row to be updated, which updating target row stores the target value of the power consumption in the bandwidth limitation table 122. The power capping controller 120A stores the current bandwidth limitation ratio in the updating target row to be updated in the bandwidth limitation table 122, based on the instruction INST.

Next, in step S24, the controller 170A determines whether or not the bandwidth limitation ratios are stored in all of the rows of the bandwidth limitation table 122. In a case where the bandwidth limitation ratios are stored in all of the rows, the controller 170A advances the process to a process of step S26, and in a case where there is a row in which the bandwidth limitation ratio is not stored, the controller 170A returns the process to the process of step S16.

In step S26, the controller 170A outputs the end instruction STOP and the selection instruction SEL for causing the selector 140A to select the memory access request MREQ to the memory controller 110A. Next, in step S28, the dummy access generator 130A stops the output of the dummy memory access request DMREQ based on the end instruction STOP, and the selector 140A is caused to assume a state where the memory access request MREQ from the core 180 is selectable based on the selection instruction SEL for selecting the memory access request MREQ. Then, the process of updating the bandwidth limitation table 122 ends.

As described above, in this embodiment, the limit value of the access bandwidth of the memory 210 is set by updating the bandwidth limitation table 122 according to the actual power consumption value of the memory 210. Hence, it is possible to minimize the individual differences in the power consumption at the time of the power capping caused by the differences in the type and configuration of the memory module 200, and to suppress a deterioration (or decrease) of the accuracy of the power capping. As a result, the power capping can be accurately controlled according to the upper limit value of the power consumption of the memory module 200 specified by the user.

The memory controller 110A includes the dummy access generator 130A that repeatedly outputs the dummy memory access request DMREQ at the time of the startup or restart of the system 300, and the selector 140A that selects the dummy memory access request DMREQ. Accordingly, the memory controller 110A can continuously output the dummy memory access request DMREQ in a cycle in which the access bandwidth of the memory module 200 becomes a maximum without depending on the operation of the core 180 at the time of the startup or restart of the system 300.

The dummy access generator 130A outputs the write access request having the large power consumption value of the memory module 200 compared to that of the read access request, as the dummy memory access request DMREQ. Thus, when the bandwidth limitation table 122 is updated, the upper limit of the actual power consumption value of the memory module 200 can be stored in the first row of the bandwidth limitation table 122.

By using the memory access counter 124 that counts the number of memory access requests MREQ issued per unit time, the power capping controller 120A can obtain the number of memory access requests MREQ issued per unit time using a simple circuit. Further, the power capping controller 120A can perform the power capping control by comparing the obtained number of memory access requests MREQ issued with the upper limit value of the number of accesses obtained from the bandwidth limitation ratio.

In the case where the number of memory access requests MREQ issued per unit time exceeds the upper limit value of the number of accesses obtained from the bandwidth limitation ratio, the power capping controller 120A outputs the entry request “ent” for causing a transition of the memory to the self-refresh mode to the memory access controller 150. Accordingly, the duration of the self-refresh mode SREF can be adjusted according to the issuance frequency of the memory access request MREQ for every unit time. As a result, the power consumption value of the memory module 200 can be reduced to less than or equal to the upper limit value instructed by the user, regardless of the access frequency of the memory module 200.

Within the unit time, the power capping controller 120 sets the memory 210 to the self-refresh mode SREF during a time period from a time when the count value exceeds the upper limit value of the number of accesses until a time when the unit time ends. Hence, it is possible to prevent the power consumption value per unit time of the memory module 200 from increasing beyond the power consumption value for the case where the number of accesses obtained from the bandwidth limitation ratio is the upper limit value.

The bandwidth limitation table 122 is updated during the initialization sequence at the time of the startup or restart of the system 300. For this reason, it possible to suppress a deterioration (or decrease) of the accuracy of power capping from the start of the operation of the system 300 according to the power consumption value unique to each memory module 200, the load of the interconnect on the system board, or the like.

According to embodiments of the present disclosure, it is possible to suppress a deterioration of a power capping accuracy by setting a limit value of an access bandwidth according to an actual power consumption value of a memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
a memory access controller configured to access a memory based on a memory access request;
a storage configured to store a plurality of limit values of an access bandwidth of the memory in association with a plurality of power consumption values of the memory, respectively;
a power capping controller configured to acquire a limit value corresponding to a specified power consumption value from the storage and control the memory access controller so that the access bandwidth is less than or equal to the acquired limit value; and
an initial setting circuit configured to repeatedly access the memory during an initialization mode, monitor a power consumption value for a case where the access bandwidth is not limited and a plurality of the power consumption values when the limit value is gradually varied, and store the plurality of limit values in the storage in association with the plurality of monitored power consumption values, respectively.

2. The processor as claimed in claim 1, further comprising:
a core configured to generate the memory access request;
an access generator configured to repeatedly generate a memory access request during the initialization mode; and
a selector configured to output the memory access request from the access generator to the memory access controller during the initialization mode, and output the memory access request from the core to the memory access controller during a mode other than the initialization mode.

3. The processor as claimed in claim 2, wherein:
the access generator generates a write access request as the memory access request at a frequency for a case where the access bandwidth is not limited.

4. The processor as claimed in claim 2, wherein:
the power capping controller includes a memory access counter configured to count a number of memory access requests output from the selector, and
the power capping controller controls the memory access controller so that a count value per unit time by the memory access counter is less than or equal to a number of accesses to the memory corresponding to the limit value of the access bandwidth.

5. The processor as claimed in claim 4, wherein:
the memory is a volatile memory that requires a periodic refresh operation to hold data, and
the power capping controller outputs an instruction for causing a transition of the memory to a self-refresh mode to the memory access controller in a case where the count value exceeds the number of accesses to the memory corresponding to the limit value of the access band, for every unit time.

6. The processor as claimed in claim 4, wherein the power capping controller outputs an instruction for causing a release of the memory from the self-refresh mode to the memory access controller, for every end of the unit time.

7. The processor as claimed in claim 1, wherein a transition to the initialization mode occurs at a time of startup of a system including the processor and the memory.

8. A system comprising:
a processor; and
a memory accessed by the processor,
wherein the processor includes:
a memory access controller configured to access the memory based on a memory access request;
a storage configured to store a plurality of limit values of an access bandwidth of the memory in association with a plurality of power consumption values of the memory, respectively;
a power capping controller configured to acquire a limit value corresponding to a specified power consumption value from the storage and control the memory access controller so that the access bandwidth is less than or equal to the acquired limit value; and
an initial setting circuit configured to repeatedly access the memory during an initialization mode, monitor a power consumption value for a case where the access bandwidth is not limited and a plurality of the power consumption values when the limit value is gradually varied, and store the plurality of limit values in the storage in association with the plurality of monitored power consumption values, respectively.

9. The system as claimed in claim 8, wherein the processor further includes:
a core configured to generate the memory access request;
an access generator configured to repeatedly generate a memory access request during the initialization mode; and
a selector configured to output the memory access request from the access generator to the memory access controller during the initialization mode, and output the memory access request from the core to the memory access controller during a mode other than the initialization mode.

10. The system as claimed in claim 9, wherein:
the access generator generates a write access request as the memory access request at a frequency for a case where the access bandwidth is not limited.

11. The system as claimed in claim 9, wherein:
the power capping controller includes a memory access counter configured to count a number of memory access requests output from the selector, and
the power capping controller controls the memory access controller so that a count value per unit time by the memory access counter is less than or equal to a number of accesses to the memory corresponding to the limit value of the access bandwidth.

12. The system as claimed in claim 11, wherein:
the memory is a volatile memory that requires a periodic refresh operation to hold data, and
the power capping controller outputs an instruction for causing a transition of the memory to a self-refresh mode to the memory access controller in a case where the count value exceeds the number of accesses to the memory corresponding to the limit value of the access band, for every unit time.

13. The system as claimed in claim 11, wherein the power capping controller outputs an instruction for causing a release of the memory from the self-refresh mode to the memory access controller, for every end of the unit time.

14. The system as claimed in claim 8, wherein a transition of the initialization mode occurs at a time of startup of the system.

15. The system as claimed in claim 8, further comprising:
a memory module including the memory, and a power management circuit configured to generate power source voltages used in the memory module and output power information indicating a power consumption of the memory module in response to a request, and
the processor further includes a power monitor controller configured to output a power consumption value of the memory module indicated by the power information read from the power management circuit to the initial setting circuit as a power monitor value.
